(19) United States
(12) Patent Application Publication
(10) Pub. No.: US 2022/0378262 A1
(43) Pub. Date: Dec. 1, 2022

(54) Vacuum-cleaner filter bag for a hand-held vacuum cleaner

(71) Applicant: Eurofilters N.V., Overpelt (BE)

(72) Inventors: Ralf Sauer, Overpelt (BE); Jan Schultink, Overpelt (BE)

(73) Assignee: Eurofilters N.V., Overpelt (BE)

(21) Appl. No.: 17/775,515

(22) PCT Filed: Oct. 28, 2020
(86) PCT No.: PCT/EP2020/080290

§ 371 Date: May 9, 2022

(30) Foreign Application Priority Data
Nov. 12, 2019 (EP) 19208500.9

(51) Int. Cl. A47L 9/14; B01D 46/02; B01D 46/52; B01D 46/00

(52) U.S. Cl. CPC A47L 9/1436; B01D 46/02; B01D 46/523; B01D 46/0001; B01D 2265/04; B01D 2279/55

(57) ABSTRACT

The invention comprises a vacuum cleaner filter bag (1), comprising a bag wall (2) and a retaining plate (3), wherein the retaining plate (3) is connected to an at least partially cylindrical connection piece (4) which extends in a direction perpendicular to a passage opening (5) formed in the retaining plate (3), wherein the bag wall (2) is connected with the lateral surface of the connection piece (4) along the circumference thereof.

The invention relates to a vacuum cleaner filter bag, in particular a vacuum cleaner filter bag for a hand-held vacuum cleaner, and/or a so-called stick vacuum cleaner, in particular for cordless models.

Stick vacuum cleaners are often, though not always, cordless units (battery-operated vacuum cleaners), wherein an electric brush is connected with the actual housing of the hand-held vacuum cleaner via a suction tube without suction hose. These units are very light and handy. The sticks have low input powers within a range of about 150 to 600 W. The achieved flow rates are correspondingly low and are in the order of 10 to 30 l/s. The filter housing is typically cylindrical and has a small volume (ca. 1 to 2 liters). In most cases, a cyclone dust collector is used as the filter. The cyclone dust collector accelerates the suction air and the particles contained therein. Thereby, a considerable portion of the available power is consumed, and not much power is left for generating a sufficient flow rate. The cleaning effect (dust absorption) is often unsatisfactory.

A filter bag from modern non-woven fabric laminates performs the collection of dust in a substantial more energy-efficient manner. However, it is difficult to produce a filter bag that optimally fits into the very small available installation space and provides a sufficient filter surface.

Classic flat bags where two filter material blanks are circumferentially welded and a retaining plate is flatly connected with one of the filter material blanks are usually unsuited since the available installation space is too small. Therefore, up to present, bags with a bottom, for example a block bottom, are mainly used where the retaining plate is arranged at the bottom and whose bag shape is adapted to the installation space (so called “three-dimensional” bags). However, it turns out to be difficult to manufacture such bags, in particular with a non-woven fabric material common today. Therefore, in the manufacture of such bags, sometimes manual production steps are still necessary which reduces the efficiency of the manufacture.

It is therefore the object of the invention to provide a vacuum cleaner filter bag that is easy to manufacture in an automated manner, in particular a vacuum cleaner filter bag for a hand-held vacuum cleaner and/or a stick vacuum cleaner, which can preferably optimally utilize the available installation space.

This object is achieved by a vacuum cleaner filter bag according to claim 1. Particularly advantageous developments can be found in the subclaims.

Thus, the invention provides a vacuum cleaner filter bag, comprising a bag wall and a retaining plate, wherein the retaining plate is connected to an at least partially cylindrical connection piece which extends in a direction perpendicular to a passage opening formed in the retaining plate, wherein the bag wall is connected with the lateral surface of the connection piece along the circumference thereof.

By the bag wall being connected with the retaining plate via the at least partially cylindrical connection piece, and with the lateral surface of the connection piece along the circumference thereof, the complex formation of a bottom during the manufacture, which is often only possible manually, is omitted. Thereby, the vacuum cleaner filter bag according to the invention can be manufactured more efficiently.

The vacuum cleaner filter bag can in particular be provided for hand-held vacuum cleaners and/or a so-called stick vacuum cleaner, in particular for cordless models. The filling volume can therefore be, in a completely unfolded state, between 0.5 and 3 liters, in particular between 0.5 and 2 liters.

The retaining plate of the vacuum cleaner filter bag may be attachable to a holding means in a vacuum cleaner housing. Thereby, the retaining plate can be arrangeable, in particular fixable, in a predetermined position within the vacuum cleaner housing.

In contrast to a flat bag, where the retaining plate is connected to a flat wall part of the bag wall, in case of the manufacture of the vacuum cleaner filter bag according to the invention, the bag wall provided with a corresponding opening is pulled over the at least partially cylindrical connection piece and connected to the lateral surface thereof. Thereby, the vacuum cleaner filter bag extends substantially in parallel to the longitudinal axis of the connection piece and thereby perpendicularly to the plane of the retaining plate. Thereby, the vacuum cleaner filter bag is also better adapted to the common filter housings of hand-held vacuum cleaners and/or stick vacuum cleaners, which are typically cylindrical and include the holding means for the retaining plate at one of the cover surfaces of the cylinder.

The at least partially cylindrical connection piece comprises a passage opening which partially or completely overlaps with the passage opening of the retaining plate in a plan view onto the retaining plate, so that an admission port is formed via which dust-charged air can flow into the interior of the vacuum cleaner filter bag in operation. The longitudinal axis of the connection piece is herein defined as the direction in which the passage opening extends in the connection piece. This direction is in particular perpendicular to the plane in which the passage opening of the retaining plate is arranged.

“At least partially cylindrical” means that the connection piece comprises at least one section that is formed in the shape of a cylinder, i.e., is defined by a lateral surface and two boundary surfaces. The cylindrical shape is here not restricted to a circular cylinder. The cross-section of the cylindrical section, that means the directrix of the general cylinder, can have any arbitrary shape. The cross-section of the cylindrical section can also be a polygon. In this case, one can also speak of a prism-shaped section. The cylindrical section can in particular have the shape of a straight or vertical cylinder, wherein the convex surface lines extend in parallel to the longitudinal axis of the connection piece.

The connection piece may comprise a second section, in particular adjacent to the cylindrical section, with an enlarged circumference compared to the cylindrical section. The second section can in particular project to the outside beyond the lateral surface of the cylindrical section. The connection piece can be connected with the retaining plate in the region of the second section.

The retaining plate may in particular be a flat component, in particular with its extension in two directions (length, width) being substantially larger, in particular at least three times larger, than in a direction perpendicular thereto (thickness). The retaining plate may in particular completely surround the passage opening arranged therein.

The retaining plate and/or the connection piece may comprise one or more plastics or consist of one or more plastics. In particular, recycled plastics can be employed, such as recycled polypropylene, rPP, and/or recycled polyethylene terephthalate, rPET. The retaining plate and the connection piece can be made of the same material.

The retaining plate may comprise a closing element for closing the inflow opening. Thereby, the sucked-in material can be retained inside the bag's interior, in particular when the bag is removed.

The retaining plate can in particular be glued or welded with the connection piece. A positive connection between the retaining plate and the connection piece, which can in particular be released nondestructively, is conceivable, for example via a bayonet catch. By the latter measure, the retaining plate can be designed to be reusable.

The retaining plate and the connection piece are thus two separately produced components which are connected to each other, in particular such that they can be released nondestructively or not nondestructively.

The retaining plate may moreover comprise a sealing lip surrounding the passage opening. The sealing lip can comprise or consist of a thermoplastic elastomer, for example based on polypropylene. The sealing lip is to prevent or restrict dust from leaking from the vacuum cleaner filter bag by sealing the region between the inner edge of the passage opening and the outer side of a connecting piece of the vacuum cleaner.

The retaining plate may be designed as a molded part or as a part produced by thermoforming. The retaining plate can also be made partially by injection-molding and partially by thermoforming. The connection piece can also be designed as a molded part and/or as a part produced by thermoforming.

The bag wall is made from an air-permeable material and can be structured in multiple layers. The latter is also referred to as a laminate. Multiple layers of the laminate, in particular each layer of the laminate, can comprise a non-woven fabric and/or a fibrous fleece or consist thereof.

As a material for the bag wall, in particular for one or several layers of non-woven fabric or fibrous fleece, many diverse plastics may be used, for example polypropylene and/or polyester. The bag wall may also comprise or consist of plastic recyclates and/or recycled material from the manufacture of textiles (Textile Left-Over—TLO).

For many plastic recyclates, there are relevant international standards. For PET plastic recyclates, for example, DIN EN 15353:2007 is relevant. PP recyclates are characterized in DIN EN 15345:2008. For the purpose of the corresponding special plastic recyclates, the present patent application adopts the definitions of these international standards. The plastic recyclates can be non-metallized. One example of this are plastic flakes or chips recovered from PET beverage bottles. Equally, the plastic recyclates can be metallized, e.g. if the recyclates have been obtained from metallic plastic foils, in particular metallized PET foils (MPET).

Recycled polyethylene terephthalate (rPET) can be obtained, for example, from beverage bottles, in particular so-called bottle flakes, that means pieces of ground beverage bottles.

The recycled plastics, in particular recycled PET and/or recycled PP, both in the metallized and in the non-metallized version, can be spun into the corresponding fibers from which the corresponding staple fibers or melt-blown or spunbond non-woven fabrics can be manufactured for the purposes of the present invention.

Recycled material from the manufacture of textiles (TLO) is in particular generated in the processing of textile materials (in particular textile fibers and filaments, and linear, planiform, and spatial textile fabrics manufactured therewith), such as, for example, the manufacture (comprising carding, spinning, cutting, and drying) or the recycling of textile materials. These pulverized and/or fibrous materials are waste materials which can deposit on the machines or filter materials used for processing the textiles. The dusts (powders) or fibers are normally disposed of and thermally utilized.

Thus, the pulverized and/or fibrous recycled material is, for example, production waste; this in particular applies to material generated during the carding, spinning, cutting, or drying of textile materials as a waste product. This is also referred to as “pre-consumer waste”.

In the recycling of textile materials, i.e. the processing (for example shredding) of used textile materials or textiles (for example old clothes), pulverized and/or fibrous recycled material is also formed, this is referred to as “post-consumer waste”.

Thus, the recycled material from the manufacture of textiles, TLO, can in particular comprise fibers and/or filaments which have been obtained from waste materials from the textile and clothing industry, from post-consumer waste (textiles and the like), and/or from products that have been collected for recycling.

In the sense of the present invention, a non-woven fabric designates a random mesh that has undergone a solidification step so that it has sufficient strength to be wound off or up from or onto rolls, for example by machines (i.e. on an industrial scale). The minimum web tension required for winding up is 0.044 N/mm. The web tension should not be higher than 10% to 25% of the minimum maximum tensile force (according to DIN EN 29073-3:1992-08) of the material to be wound up. This results in a minimum maximum tensile force for a material to be wound up of 8.8 N per 5 cm of the strip width.

A fibrous nonwoven, briefly only referred to as “nonwoven”, corresponds to a random mesh which, however, has not undergone a solidification step, so that in contrast to a non-woven fabric, such a random mesh does not have sufficient strength to be wound off or up, respectively, onto or from rolls, for example, by machines.

The term non-woven fabric (“non-woven”) is used in other words according to the definition of ISO Standard IS09092:1988 or CEM Standard EN29092. Details of the use of the definitions and/or methods described herein can also be taken from the standard work “Vliesstoffe”, W. Albrecht, H. Fuchs, W. Kittelmann, Wiley-VCH, 2000.

The non-woven fabric layers of the bag wall may in particular comprise a staple fiber non-woven fabric and or an extrusion non-woven fabric. In particular, spun-bond nonwovens (briefly also “spun-bond web” or spunbond”), and/or melt-blown non-woven fabric can be used.

One or several layers of the bag wall may comprise a carded material. As a bonding step, mechanical methods (e.g. needling) as well as thermal methods (e.g. calendaring) are possible. Equally, the use of binding fibers or adhesives, such as a latex adhesive, is possible. Airlaid materials are also possible.

The non-woven fabric of one or several layers of the bag wall can comprise bicomponent fibers. Bicomponent fibers (bico fibers) can be formed of a core and an envelope enclosing the core. Apart from core/envelope bicomponent fibers, the other common variations of bicomponent fibers, e.g. side-by-side, can be employed.

The bicomponent fibers can be present as staple fibers or be formed as filaments in an extrusion non-woven fabric (for example, melt-blown non-woven fabric).

Correspondingly, non-solidified fibrous fleeces are also conceivable, as mentioned.

The non-woven fabric of one or several layers of the bag wall can moreover include a micro-creping (Micrex).

The bag wall may also comprise an odor absorbent.

The bag wall may in particular comprise a capacity layer. A capacity layer offers high resistance against shock loads and permits to filter large particles of dirt, to filter a significant proportion of small particles of dirt, and to store or retain high amounts of particles, the air being allowed to easily flow through, thus resulting in a low pressure drop with a high particle load.

The bag wall may also comprise a fine filter layer. A fine filter layer serves to increase the filtration performance of the multi-layer filter material by capturing particles which penetrate, for example, the capacity layer. To further increase the separation performance, the fine filter layer can be preferably charged electrostatically (e.g. by corona discharge or hydro-charging), in particular to increase the separation of particulate matter.

The fine filter layer can follow the capacity layer in particular towards the outer side of the bag wall.

A support layer may adjoin the fine filter layer. A support layer (sometimes also referred to as “reinforcement layer”) is here a layer that imparts the required mechanical strength to the multi-layer bond of the filter material. The support layer may, in particular, be an open, porous non-woven fabric with a light surface weight. The support layer may, in particular, be a spun-bonded nonwoven.

However, it is also possible to employ a single-layer filter material for the bag wall. In this case, it may in particular be a melt-blown non-woven fabric. A suited material for such a single-layer bag wall is known, for example, from EP 2 311 360 B1.

The bag wall may, in particular, be connected with the outer side of the connection piece, i.e., with the side of the connection piece facing away from the passage opening. This permits an advantageous optical control of the fastening process in the manufacture, in particular visually and/or via automated image processing.

The length of the side of the bag wall connected with the connection piece may, in particular, correspond to the outer circumference of the cylindrical section of the connection piece. The bag wall may, in particular, be connected with the lateral surface of the connection piece along the complete circumference thereof. Both the bag wall and the lateral surface of the cylindrical section of the connection piece thereby surround the passage opening of the connection piece across its complete circumference.

The bag wall may be glued or welded to the lateral surface, and/or the bag wall can be clamped between the lateral surface and a clamping element. The clamping element may in particular be a hollow cylinder. In this case, one can also speak of a clamping ring. The fastening only via a clamping element permits a releasable connection and thereby a reuse of the retaining plate and the connection piece.

The retaining plate and the connection piece may be arranged at a short side of the bag wall. In other words, the longitudinal axis of the vacuum cleaner filter bag can extend in parallel to the longitudinal axis of the connection piece.

The bag wall can include a surface pleating with at least five pleats. The surface pleating of the filter medium has considerable advantages. Due to the surface pleating, the area through which air flows is substantially larger than the regular area available for the passage of air (face area). By the surface pleating, the bag wall can in other words be at least partially pleated.

The term pleating is defined, in the sense of the present invention, as a sequence of two or several pleats, wherein a single pleat in the sense of the present invention is each defined by two pleat legs and one pleat hinge.

A surface pleating is a sequence of pleats provided on the bag wall. Such a surface pleating is, if need be, fixed along a side edge by a portion of the seam. This portion of the seam, however, is neither a pleat hinge nor part of the pleat leg of one of the pleats of the pleating.

The vacuum cleaner filter bag, in particular its bag wall, may moreover comprise at least one side pleating.

A side pleating is a sequence of pleats in the region of the side edge of the vacuum cleaner filter bag. The seam along the respective side edge of the vacuum cleaner filter bag is here a portion of one of the pleats forming the side pleat; for example, the seam in the region of the respective side edge is a pleat hinge, or the seam is almost completely situated within a pleat leg.

The at least five pleats of the surface pleating can extend along the longitudinal axis of the filter bag. As an alternative, the pleats can, however, also extend transversely to the longitudinal axis.

Moreover, a fixing device can be provided which prevents at least one of the five pleats from completely unfolding.

The pleats of a bag wall can be interconnected at least partially by means of a fixing device. By the fixing device, pleats of the bag wall can also be held at a predetermined distance from each other.

The fixing device can comprise at least one material strip, in particular a non-woven fabric material strip, or consist of at least one material strip, in particular at least one non-woven fabric material strip. A plurality of material strips can be arranged spaced apart with respect to each other or be directly adjacent to each other.

A plurality of material strips can extend transversely, in particular perpendicularly to or at a predetermined angle with respect to the longitudinal direction of the pleats. The predetermined angle can be greater than 0° and smaller than 180°, in particular greater than 30° and smaller than 150°.

The fixing device is preferably arranged on the upstream side with respect to the bag wall. On the upstream side here means facing the interior of the vacuum cleaner filter bag. The fixing device may be connected with the bag wall at least partially, in particular with the pleats of the bag wall, in particular connected directly, in particular glued and/or welded. The fixing device may furthermore be glued and/or welded at locations where pleat legs of two different pleats of the bag wall are adjacent to each other.

The fixing device may be glued and/or welded to the bag wall in one or several regions of the bag wall which are each arranged between two pleats of the bag wall. In particular in case of horizontal pleats which do not mutually overlap, a simple manufacture of the vacuum cleaner filter bag can be achieved thereby.

Two or more pleats of the bag wall can also be interconnected by the fixing device, while two or more pleats of the bag wall are not interconnected by the fixing device.

As an alternative or in addition, the fixing device may be glued and/or welded to one or several pleats of the bag wall such that the connection is released during the operation of the vacuum cleaner filter bag. Thereby, by the at least partially releasing fixing device, the air flow within the vacuum cleaner filter bag can be influenced.

In other words, parts of the fixing device can serve as an air diffuser during the operation of the vacuum cleaner filter bag.

The surface pleats, side pleats and/or fixing devices may, in particular, be designed as described in European Patent Application EP 2 366 319, or European Patent Application EP 2 366 320.

The side of the bag wall opposite the retaining plate may be designed to be concave or convex. By this, a better utilization of the installation space can be achieved.

The invention also provides a method of manufacturing a vacuum cleaner filter bag according to claim 10, in particular of manufacturing a vacuum cleaner filter bag described above. Thus, the method according to the invention comprises the following steps:
a) forming a tubular bag from a filter material which is open on one side;
b) arranging a at least partially cylindrical connection piece at the wide end of a conical guiding element, so that the connection piece rests against the outer surface of the conical guiding element;
c) slipping the bag over the conical guiding element;
d) connecting the bag to the lateral surface of the connection piece facing away from the guiding element;
e) lifting the bag connected with the connection piece from the guiding element; and
f) connecting the connection piece with a retaining plate.

This method permits an efficient and automated manufacture.

The formation of the tubular bag open on one side may comprise an overlapping of two filter material webs and the formation of two longitudinal and one transverse weld seams. As an alternative, the formation of the tubular bag open on one side can comprise the folding-over of one single filter material web, and the formation of a longitudinal weld seam for connecting two edges of the filter material web that overlap after the folding-over, and the formation of a transverse weld seam.

The formation of the tubular bag open on one side can moreover comprise the formation of the above-described surface pleating and/or side pleating.

The surface pleating may be in particular introduced along the conveying direction of the filter material web. If the pleats are to extend along the longitudinal direction of the vacuum cleaner filter bag, the open side is provided transverse to the conveying direction of the filter material web. If the pleats are to extend transversely to the longitudinal direction of the vacuum cleaner filter bag, the open side is provided in the conveying direction of the filter material web.

The conical guide element can be arranged on a working table, in particular a rotary table. A plurality of conical guiding elements can in particular be provided, in particular along the circumference of the rotary table. The radius of the conical guiding element can in particular decrease away from the surface of the working table.

The conical guiding element may be configured such that its diameter is variable or adjustable at the surface of the working table. For example, the conical guiding element may be arranged in a passage opening of the working table and be movable perpendicularly to the surface of the working table. As an alternative, the conical guiding element can be formed of a plurality of radially movable elements.

To arrange the at least partially cylindrical connection piece at the wide end of a conical guiding element may comprise slipping the connection piece over the conical guiding element. The inner diameter of the at least partially cylindrical connection piece, i.e., the diameter of its above-mentioned passage opening, may correspond to the outer diameter of the conical guiding element at the surface of the working table, so that the connection piece abuts against the outer surface of the conical guiding element. For this, the conical guiding element can include a cylindrical section at its broad end whose shape and dimension corresponds to the shape and dimension of the cylindrical section of the connection piece, wherein, however, the outer radius of the cylindrical section of the conical guiding element corresponds to the inner diameter of the cylindrical section of the connection piece.

The slipping of the bag over the conical guiding element may comprise a gripping and opening of the tubular bag open on one side. The pulling-over of the bag over the conical guiding element can in particular be carried out by a robot gripper in an automated manner.

In case of pleats that are provided transversely to the longitudinal direction of the vacuum cleaner filter bag, the open side of the bag is provided in the conveying direction of the filter material web. In this case, the robot gripper rotates the bag before it pulls it over the conical guiding element.

In case of pleats that are provided in the longitudinal direction of the vacuum cleaner filter bag, the open side of the bag is provided transversely to the conveying direction of the filter material web. In this case, the robot gripper can pick up the bag in the conveying direction of the filter material web and pull it over the conical guiding element.

The connecting of the bag to the lateral surface of the connection piece facing away from the guiding element can in particular be effected by ultrasonic welding. In this case, the conical guiding element forms the anvil for the sonotrode. The welding can be carried out in several steps. For example, a rotary table can be used to move the conical guiding element with the pulled-over bag to different welding stations which are arranged and embodied such that they weld different segments of the circumference of the connection piece to the bag wall. As an alternative, a welding sonotrode movable in the circumferential direction can be used.

As an alternative or in addition, the connecting of the bag to the lateral surface of the connection piece facing away from the guiding element may comprise an arrangement of a clamping element over the bag wall, so that the bag wall is clamped in a region of the lateral surface of the connection piece between the lateral surface of the connection piece and the clamping element.

The lifting of the bag connected to the connection piece from the guiding element can again be effected via a robot gripper in an automated manner. The lifting of the bag connected to the connection piece from the guiding element may moreover comprise a reduction of the diameter of the conical guiding element at the surface of the working table, for example by lowering the conical guiding element in a through hole of the working table.

The connecting of the connection piece to a retaining plate may comprise gluing, welding, and/or a positive connection, as stated above.

The method may moreover comprise an optical control of the connection between the bag wall and the lateral surface according to step d). In particular, at least one digital image of the connection region of the bag wall with the lateral surface can be created. This digital image can be subjected to automated image processing to detect errors at the connection, for example insufficiently formed weld seams. Based on the detection of an insufficient connection, a warning signal can be emitted, and/or the respective bag can be discharged.

Further features and advantages of the invention will be described below with reference to the exemplary figures. In the figures:

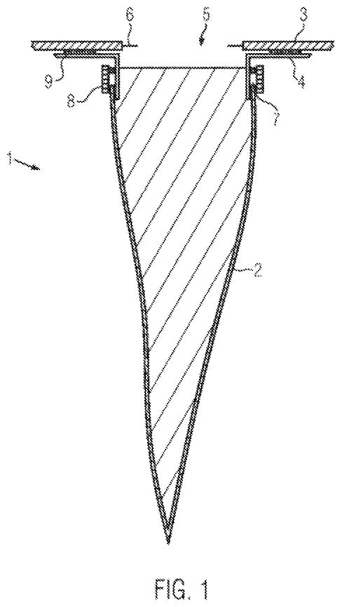

FIG. 1 shows a cross-section through an exemplary vacuum cleaner filter bag;

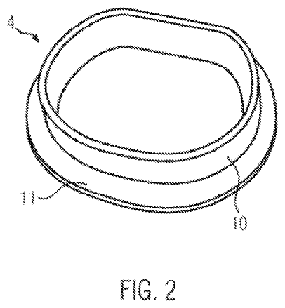

FIG. 2 shows a perspective view of an exemplary at least partially cylindrical connection piece;

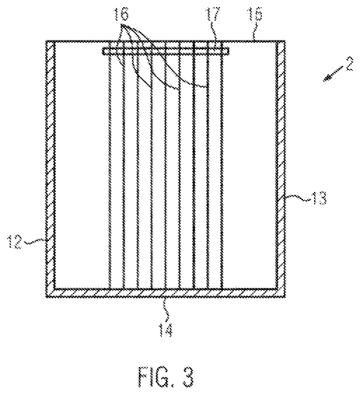

FIG. 3 shows a plan view onto an exemplary tubular bag open on one side for manufacturing a vacuum cleaner filter bag;

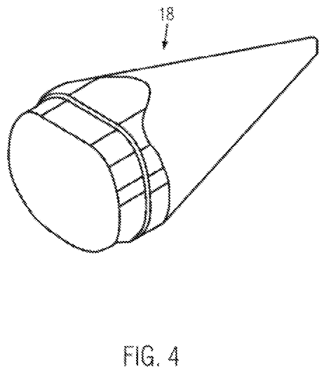

FIG. 4 shows a perspective view of an exemplary conical guiding element for manufacturing a vacuum cleaner filter bag; and

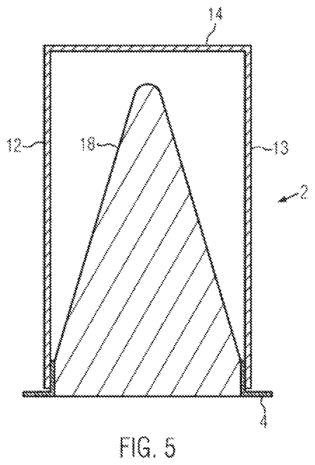

FIG. 5 shows an illustration of a production step in the manufacture of an exemplary vacuum cleaner filter bag.

FIG. 1 shows a cross-section through an exemplary vacuum cleaner filter bag 1 with a bag wall 2 and a retaining plate 3. The retaining plate 3 is used for fixing the vacuum cleaner filter bag in a corresponding mounting in a housing of a vacuum cleaner.

The bag wall is not, as common in prior art, directly connected with the retaining plate, but with an at least partially cylindrical connection piece 4. In particular, the connection piece extends in a direction perpendicular to a passage opening 5 formed in the retaining plate 3, i.e., perpendicular to the plane in which the passage opening 5 is located. The bag wall 2 is connected with the lateral surface of the connection piece 4 along the circumference thereof which also extends in the direction perpendicular to the passage opening 5 formed in the retaining plate 3.

FIG. 2 shows a perspective view of an exemplary at least partially cylindrical connection piece 4. The connection piece 4 comprises a cylindrical section 10. The shape of the cylindrical section 10 can be freely selected and is not restricted to the shape of a circular cylinder. The axis of the cylindrical section 10 defines the longitudinal axis of the connection piece 4. Along this longitudinal axis of the cylindrical section 10, a passage opening is provided. Together with the passage opening 5 of the retaining plate 3, this passage opening forms an admission port for the sucked-in material into the filter bag, as can be seen in FIG. 1.

The exemplary connection piece 4 of FIG. 2 comprises a second section 11 adjacent to the cylindrical section 10 with an enlarged circumference compared to the cylindrical section 10. The second section 11 in particular projects radially to the outside beyond the lateral surface of the cylindrical section 10. The connection piece 4 can be connected with the retaining plate 3 in the region of the second section 11, as is shown in FIG. 1.

FIG. 1 in particular shows that the connection piece 4 is connected to the retaining plate via a weld seam 9. Instead of the weld seam 9, an adhesive connection or a positive connection could also be used.

The bag wall 2 is welded to the lateral surface of the cylindrical section 10 of the connection piece 4 in the embodiment of FIG. 1. One can in particular see the ultrasonic weld seams 7. In addition, a clamping ring 8 is shown in this embodiment which clamps the bag wall 2 to the lateral surface of the cylindrical section 10 of the connection piece 4. Such a clamping ring 8 can also create the connection of the bag wall with the lateral surface alone.

In the embodiment of FIG. 1, a sealing lip 6 at the passage opening 5 is also shown.

FIG. 3 shows a plan view onto an exemplary tubular bag open on one side as it can be employed in the manufacture of a vacuum cleaner filter bag according to FIG. 1. The bag wall 2 of the exemplary bag of FIG. 3 comprises two longitudinal weld seams 12, 13 and one transverse weld seam 14. At the transverse side 15, the bag is open, that means without a weld seam, to permit there a connection with a connection piece as shown in FIG. 2 by way of example.

The transverse weld seam 14 could also be designed to be concavely or convexly bent to better utilize the installation space. A bottom, for example like a block bottom, or a side pleat would also be conceivable in the region of the transverse weld seam 14.

Moreover, the bag wall 2 in FIG. 3 comprises a plurality of surface pleats 16 extending along the longitudinal weld seams 12, 13. At the open end 15, the pleats are fixed in their positions via a fixing device 17.

As already illustrated above, the term pleating is defined, in the sense of the present invention, as a sequence of two or several pleats, wherein a single pleat in the sense of the present invention is each defined by two pleat legs and one pleat hinge.

A pleat hinge is understood as the point of a pleat with the smallest radius of curvature. By the imaginary connection of the pleat hinges, a so-called pleat axis is obtained. The pleat axis is also referred to as pleat back. The pleat axis can correspond to the longitudinal axis of a pleat. Regions of a pleat with a radius of curvature that is larger than the minimum radius of curvature of the pleat are referred to as pleat leg. The region located between the pleat legs of a pleat is referred to as pleat core. The pleat legs of one pleat can in particular also include a curvature.

Pleats can also include points of inflection. Points of inflection are those locations of a pleat, in particular the pleat legs, where the curvature of the pleat changes from concave to convex. A connection line connecting several points of inflection of a pleat is referred to as inflection line (line of inflection).

Two adjacent pleats can also share one pleat leg. If a plurality of pleats are provided in this manner, a pleat pack or a pleat array can be realized.

A plurality of pleats can also be arranged in zigzag form.

Pleats may also have legs which extend in parallel to the bag wall. Such legs can be located between pleats that project from the plane of the bag wall and thus have an opening on the face side with respect to the bag wall. In particular, the width of the parallel leg can here be smaller than the width of the opening of the pleat projecting from the bag wall, preferably smaller than half of or most preferably smaller than one fourth of said width.

The pleat legs of the pleats can in particular be smooth. “Smooth” here means that the pleat legs do not include any compactions and/or structuring which are in particular to stabilize the shape of the pleats.

One or more pleat legs of one or more pleats can comprise one or more embossed structures, in particular wherein the embossed structures do not serve to stabilize the shape of the pleats. Thereby, a further enlargement of the area available for filtration can be achieved.

The bag wall 2 can in particular include more than 5, 10, 20, 30, 40 or 50 pleats, in particular also folds of these pleats.

The pleats of the bag wall can include a substantially regular distance with respect to each other. In other words, the distance between the pleat backs of two adjacent pleats each can be substantially constant.

Pleatings can be designed to be horizontal or vertical. Horizontal pleatings are to be understood as pleatings whose pleat legs are arranged substantially in parallel to the bag wall 2. Vertical pleatings are to be understood as pleatings whose pleat legs include an angle with the bag wall 2 that is greater than 0° and smaller than 180°, in particular greater than 20° or greater than 45°.

A vertical pleating is also understood as a pleating wherein a plane in which both the pleat axis and the line of inflection of the pleat are lying includes, with a plane horizontal surface on which the first and/or second bag wall is arranged, an angle greater than 45°, in particular greater than 30°, in particular greater than 10°. A lying pleating can in this case be understood as a pleating wherein the plane with this surface includes an angle smaller than 45°, in particular smaller than 30°, in particular smaller than 10°.

To measure or determine the above-mentioned angles, the vacuum cleaner filter bag, in particular the pleated non-woven fabric material, is arranged on a plane horizontal surface. To this end, the vacuum cleaner filter bag can also be cut open and in particular arranged on the surface such that the face side or inner side of the original vacuum cleaner filter bag rests on the surface.

Horizontal pleatings can be designed to mutually overlap, not overlap, and/or partially overlap.

For the manufacture of an exemplary vacuum cleaner filter bag as shown in FIG. 1, it is required to connect the bag wall 2 with the connection piece 4. Although the connection piece 4 of plastic has a certain strength, it is advantageous in case of a connection by welding to provide an anvil which forms an abutment. FIG. 4 shows such an anvil in the form of a conical guiding element 18.

As is shown in FIG. 5, the conical guiding element 18 can be arranged vertically on a working table. The conical guiding element 18 is designed such that its outer diameter at the broad end corresponds to the inner diameter of the cylindrical section of the connection piece 4. The connection piece 4 is then pulled over the conical guiding element 18, as is shown in FIG. 5. A robot gripper can then grip a tubular bag open on one side, as shown in FIG. 3, for example, and also pull it over the conical guiding element 18. Here, too, the conical shape of the guiding element 18 is advantageous. Thereupon, a welding of the bag wall 2 to the lateral area of the cylindrical section 10 of the connection piece 4 can be accomplished from outside. The latter has the advantage that the welding result can be controlled, for example via image processing.

Finally, the connection piece 4 and the bag wall 2 connected therewith are withdrawn from the conical guiding element 18. Finally, a connection of the connection piece 4 with a retaining plate 3 is accomplished, for example, also via ultrasonic welding.

It is understood that features mentioned in the above-described embodiments are not restricted to these special combinations and are also possible in any other combination. It will be furthermore understood that geometries shown in the figures are only given by way of example and are also possible in any other embodiments.

1. A vacuum cleaner filter bag, comprising a bag wall and a retaining plate, wherein the retaining plate is connected to an at least partially cylindrical connection piece which extends in a direction perpendicular to a passage opening formed in the retaining plate, and wherein the bag wall is connected to a lateral surface of the connection piece along a circumference thereof.

2. The vacuum cleaner filter bag according to claim 1, wherein the bag wall is glued or welded to the lateral surface of the connection piece.

3. The vacuum cleaner filter bag according to claim 1, wherein the connection piece is glued or welded or positively connected to the retaining plate.

4. The vacuum cleaner filter bag according to claim 1, wherein the retaining plate and the connection piece are arranged at a short side of the bag wall.

5. The vacuum cleaner filter bag according to claim 1, wherein the bag wall includes a surface pleating with at least five pleats.

6. The vacuum cleaner filter bag according to claim 5, wherein the at least five pleats extend along a longitudinal axis of the vacuum cleaner filter bag or transverse to the longitudinal axis of the vacuum cleaner filter bag.

7. The vacuum cleaner filter bag according to claim 5, further comprising a fixing device which prevents at least one of the at least five pleats from completely unfolding.

8. The vacuum cleaner filter bag according to claim 1, further moreover comprising at least one side pleating.

9. The vacuum cleaner filter bag according to claim 1, wherein a side of the bag wall opposite the retaining plate is designed to be concave or convex.

10. A method of manufacturing a vacuum cleaner filter bag having a bag wall and a retaining plate, wherein the retaining plate is connected to an at least partially cylindrical connection piece which extends in a direction perpendicular to a passage opening formed in the retaining plate, and wherein the bag wall is connected to a lateral surface of the connection piece along a circumference thereof, the method comprising the steps of:
a) forming a tubular bag from a filter material which is open on one side;
b) arranging the at least partially cylindrical connection piece at a wide end of a conical guiding element, so that the connection piece abuts against an outer surface of the conical guiding element;
c) slipping the tubular bag over the conical guiding element;
d) connecting the tubular bag to the lateral surface of the connection piece facing away from the conical guiding element;
e) lifting the tubular bag connected with the connection piece from the conical guiding element; and
f) connecting the connection piece to the retaining plate.

11. The method according to claim 10, wherein the bag wall is glued or welded to the lateral surface of the connection piece.

12. The method according to claim 10, wherein the connection piece is glued or welded or positively connected to the retaining plate.

13. The method according to claim 10, wherein the retaining plate and the connection piece are arranged at a short side of the bag wall.

14. The method according to claim 10, wherein a side of the bag wall opposite the retaining plate is designed to be concave or convex.

15. The vacuum cleaner filter bag according to claim 1, wherein the bag wall is clamped between the lateral surface of the connection piece and a clamping element.

16. The vacuum cleaner filter bag according to claim 2, wherein the connection piece is glued or welded or positively connected to the retaining plate.

17. The vacuum cleaner filter bag according to claim 2, wherein the retaining plate and the connection piece are arranged at a short side of the bag wall.

18. The vacuum cleaner filter bag according to claim 4, wherein the bag wall includes a surface pleating with at least five pleats.

19. The vacuum cleaner filter bag according to claim 4, further comprising at least one side pleating.

20. The vacuum cleaner filter bag according to claim 4, wherein a side of the bag wall opposite the retaining plate is designed to be concave or convex.
